(19) United States
(12) Patent Application Publication
(10) Pub. No.: US 2015/0127836 A1
(43) Pub. Date: May 7, 2015

(54) METHOD FOR OPERATING CLOUD SERVER DEVICE, METHOD FOR OPERATING CLIENT DEVICE, AND CLIENT DEVICE

(71) Applicant: LG ELECTRONICS INC., Seoul (KR)

(72) Inventors: Janghun Bae, Seoul (KR); Younghwan Kwon, Seoul (KR); Hyeonjae Lee, Seoul (KR)

(21) Appl. No.: 14/401,440

(22) PCT Filed: May 14, 2013
(86) PCT No.: PCT/KR2013/004250

§ 371 Date: Nov. 14, 2014

Related U.S. Application Data
(60) Provisional application No. 61/646,373, filed on May 14, 2012.

(51) Int. Cl. H04L 29/08

(52) U.S. Cl. CPC H04L 67/141
USPC 709/227

(57) ABSTRACT

An operation method of a first client device is provided. The client device transmits device information to a cloud server device. The client device receives an operational state of a second client device from the cloud server device. The client device establishes a logical session with the second client device based on the operational state. The client device transmits a first event through the logical session. The first event is transmitted to the second client, preferentially over a second event which does not go through any logical session.

### BACKGROUND OF THE INVENTION

1. Field of the Invention

The present invention relates to an operation method of a cloud server device included in a cloud system, an operation method of a client device, and a client device.

2. Description of the Related Art

As a variety of electronic devices have enhanced in communication technology and computation capability, network may be accessed, multimedia may be played, and various applications can be driven, by using smartphones, digital TVs, etc, as well as desktop computers. Thus, the number of electronic devices that each individual may use to access a network, play multimedia, and drive various applications amounts to up to four to five electronic devices. Due to this tendency, users want user experience (UX) to easily, integrally use various devices. Thus, recently, cloud systems that help users easily use single information in various electronic devices tend to be important.

A cloud system refers to a computer environment in which information such as a multimedia file, an application, etc., are stored in a server on a network and electronic devices such as a desktop computer, a tablet computer, a notebook computer, a netbook, a smartphone, a digital TV, etc., to download and use such information. A cloud server device refers to a server storing such information in the cloud system. Client devices refer to electronic devices that may be connected to a cloud server to access information stored in the cloud server. Namely, in a cloud system, all information of users may be stored in a server on a network and may be used through various electronic devices at any time and anywhere. For an operation of the cloud system, client devices need to be synchronized.

Synchronization refers to that when information is input to a certain client device, the information is stored in a cloud server device and the information is applied in the same manner to other client devices of the user. Here, synchronization may be applied to electronic devices of other users set to share information, as well as the electronic devices of the same user. Thus, in the cloud system, fast, convenient synchronization technique is an important factor that determines performance of the cloud system.

As the number of users managed by a cloud server device increases and the number of client devices connected thereto increases, an amount of data to be processed by a server increases. This may result in a reduction in the speed of synchronization, causing user inconvenience. Thus, rapid synchronization of a cloud server device and client devices included in a cloud system that provide services for a large number of users need to be guaranteed.

### SUMMARY

An aspect of the present invention provides an operation method of a cloud server device for rapid synchronization of client devices which belong to the same user or which are set to share information.

Another aspect of the present invention provides an operation method of a client device for rapid synchronization of client devices which belong to the same user or which are set to share information.

Another aspect of the present invention provides a client device for rapid synchronization of client devices which belong to the same user or which are set to share information.

According to an aspect of the present invention, there is provided an operation method of a first client device, including: transmitting, by the first client device, user account information to a cloud server device; receiving, by the first client device, an operational state of a second client device from the cloud server; establishing, by the first client device, a logical session with the second client device based on the operational state of the second client device; and transmitting, by the first client device, a first event through the logical session, wherein the first event is transmitted to the second client device preferentially over a second event that does not go through any logical session.

The operational state may include whether the second client device has accessed an account, and the establishing of a logical session may include: when the second client device accesses an account that the first client device has accessed, establishing the logical session.

The operational state may include whether the second client device has accessed an account, and the establishing of a logical session may include: when the second client device accesses an account in a sharing relationship with the account that the first client device has accessed, establishing the logical session.

The operational state may include whether power of the second client device is turned on, and the establishing of a logical session may include: when power of the second client device is turned on, establishing the logical session.

The logical session may be a session established between the first client device and the second client device through the cloud server device.

The logical session may be a session established between the first client device and the second client device, without going through the cloud server device.

The event may be a synchronization event.

According to another aspect of the present invention, there is provided a first client device including: a network interface configured to connect a cloud server device and a second client device to the first client device; and a controller configured to transmit device information to the cloud server device, receive an operational state of the second client device from the cloud server device, establish a logical session with the second client device based on the operational state of the second client device, and transmit a first event through the logical session, wherein the first event is transmitted to the second client device preferentially over a second event that does not go through any logical session.

According to another aspect of the present invention, there is provided an operation method of a cloud server device, including: receiving a first event from a first client device; determining whether the first event is an event for a second client device in a logical session established with the first client device; and processing the first event preferentially over a second event for a third client device for which any logical session has not been established.

The operation method of a cloud server device according to an embodiment of the present invention guarantees rapid synchronization between client devices which belong to the same user or which are set to share information.

The operation method of a client device according to another embodiment of the present invention guarantees rapid synchronization between client devices which belong to the same user or which are set to share information.

The client device according to another embodiment of the present invention guarantees rapid synchronization between client devices which belong to the same user or which are set to share information.

### BRIEF DESCRIPTION OF THE DRAWINGS

FIG. 1 is a block diagram illustrating a synchronization operation of a cloud system according to an embodiment of the present invention.

FIG. 2 is a block diagram of a cloud server device and cloud devices illustrating a synchronization operation in a cloud system according to an embodiment of the present invention.

FIG. 3 is a ladder diagram illustrating a synchronization operation of the cloud system according to an embodiment of the present invention.

FIG. 4 is a view illustrating inputting and outputting of an event queue of a cloud server device and an operation of an event processing module according to an embodiment of the present invention.

FIG. 5 is a flow chart illustrating processing of a synchronization event of a cloud server device according to an embodiment of the present invention.

FIG. 6 is a ladder diagram illustrating a synchronization operation of a cloud system according to another embodiment of the present invention.

FIG. 7 is a ladder diagram illustrating comparison between a synchronization operation of a cloud system according to an embodiment of the present invention and a synchronization operation thereof according to another embodiment of the present invention.

FIG. 8 is a view illustrating an example of an operation method of an event processing module of a cloud server device according to another embodiment of the present invention.

FIG. 9 is a view illustrating another example of an operation method of an event processing module of a cloud server device according to another embodiment of the present invention.

FIG. 10 is a flow chart illustrating synchronization event processing of a cloud server device according to another embodiment of the present invention.

FIG. 11 is a ladder diagram illustrating a synchronization operation of a cloud system according to another embodiment of the present invention.

FIG. 12 is a view illustrating graphic user interface (GUI) screens illustrating synchronization of image files among client devices according to an embodiment of the present invention.

### DETAILED DESCRIPTION

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, in order to clarify the present invention, parts irrespective of description have been omitted, and similar reference numerals are used for the similar parts throughout the specification.

Throughout the specification, unless explicitly described to the contrary, the word “comprise” and variations such as “comprises” or “comprising”, will be understood to imply the inclusion of stated elements but not the exclusion of any other elements.

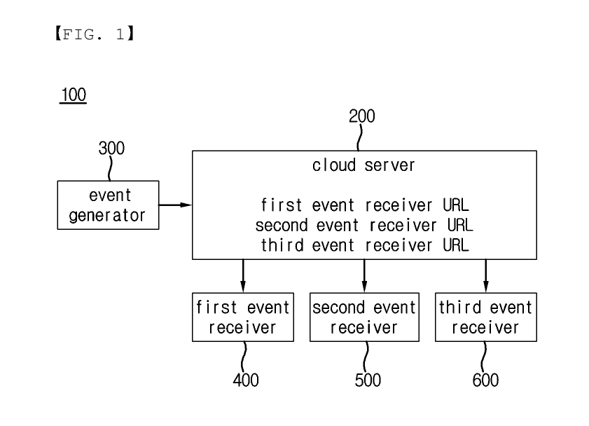

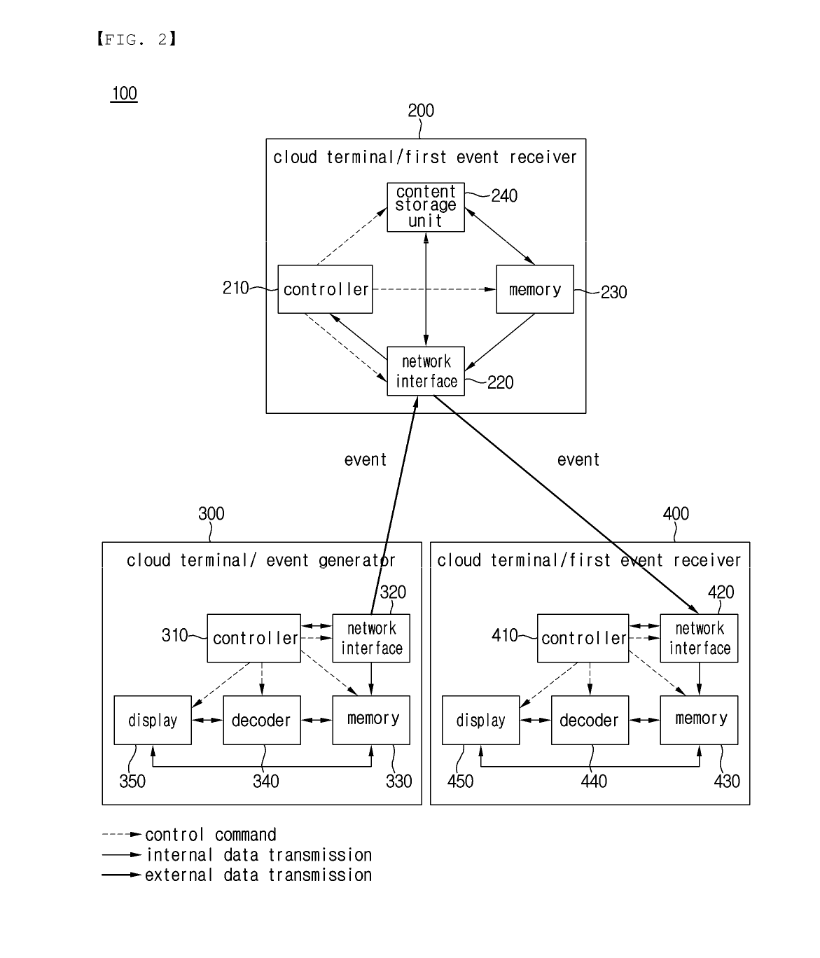

A synchronization operation according to an embodiment of the present invention will be described with reference to FIGS. 1 and 2.

FIG. 1 is a block diagram illustrating a synchronization operation of a cloud system according to an embodiment of the present invention.

A cloud system 100 includes a cloud server device 200 and a plurality of client devices. In the embodiment of FIG. 1, the plurality of client devices include an event generator 300, a first event receiver 400, a second event receiver 500, and a third event receiver 600. However, the present invention is not necessarily limited thereto.

An event refers to a message requesting a certain operation from the cloud server device 200 and the client devices. Upon receiving an event, the client server device 200 and the client devices perform an operation according to the event. A synchronization event is an event requesting synchronization from client devices which belong to the same user or which are set to share information.

The cloud server device 200 stores various types of information for a user. Various types of information may be a multimedia file, document data, an application and application data, social network service (SNS) data, a mail, etc. When a synchronization event occurs, the cloud server device 200 receives the event and transmits the received event other client devices which belong to the same user or which are set to share information.

The event generator 300, a client device which belong to the cloud system 100, generate a synchronization event when an operation requires synchronization. The generated event is transmitted to the cloud server device 200. Editing, adding, and deleting of a multimedia file or a document file within the event generator 300 may be an operation that requires synchronization. Also, adding a new application or deleting an application may be an operation that requires synchronization. Editing, adding, and deleting application data, such as correcting a schedule or adding, deleting, etc., a schedule in a schedule management program may be an operation that requires synchronization. Also, editing, adding, and deleting data of a social network service, creating a new mail, or editing and deleting a mail may be an operation that requires synchronization.

The first event receiver 400, the second event receiver 500, and the third event receiver 600 are client devices which belong to the same user or which are set to share information, and receive a synchronization event from the cloud server device 200. The first event receiver 400, the second event receiver 500, and the third event receiver 600 receive an event and perform synchronization according to the event.

The event generator 300, the first event receiver 400, the second event receiver 500, and the third event receiver 600 are all client devices, and client devices may become the event generator 300 or an event receiver, namely, the first event receiver 400, the second event receiver 500, and the third event receiver 600, according to situations. Also, in FIG. 1, only the event generator 300, the first event receiver 400, the second event receiver 500, and the third event receiver 600 are illustrated, but there is no limitation in the number of client devices that may access the client server device.

FIG. 2 is a block diagram of a cloud server device and cloud devices illustrating a synchronization operation in a cloud system according to an embodiment of the present invention.

The cloud server device 200 includes a controller 210, a network interface 220, a memory 230, and a content storing unit 240.

The controller 210 controls an operation of the cloud server device 200.

The network interface 220 connects the cloud server device 200 and the client devices. Namely, the network interface 220 is a physical device enabling the cloud server device 200 to transmit and receive an event and various data to and from the client devices in a network. As a method for a network connection, Ethernet, a wireless local area network (WLAN) (Wi-Fi), wireless broadband (Wibro), world interoperability for microwave access (Wimax), high speed downlink packet access (HSDPA), etc., may be used.

The memory 230 stores data required for an operation of the cloud server device 200. However, the memory 230 may be omitted according to a specific embodiment. In particular, the memory 230 may include one or more types of storage mediums including a flash memory, a hard disk, a multimedia card micro type memory, a card-type memory (e.g., SD or DX memory, etc), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The content storage unit 240 is a physical device that stores content such as user's multimedia file, document, application, application data, social network message, etc. In particular, the content storage unit 240 may include one or more types of storage mediums including a flash memory, a hard disk, a multimedia card micro type memory, a card-type memory (e.g., SD or DX memory, etc), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The event generator 300 includes a controller 310, a network interface 320, a memory 330, a decoder 340, and a display unit 350.

The controller 310 controls an operation of the event generator 300.

The network interface 320 connects the event generator 300 to the cloud server device 200 or the first event receiver 400. Namely, the event generator 300 is a physical device that may transmit and receive an event and various data to and from the cloud server device 200 or other client device. As a method for a network connection, Ethernet, a wireless local area network (WLAN) (Wi-Fi), wireless broadband (Wibro), world interoperability for microwave access (Wimax), high speed downlink packet access (HSDPA), etc., may be used.

The memory 330 stores data required for an operation of the event generator 300. However, the memory 330 may be omitted according to a specific embodiment. In particular, the memory 330 may include one or more types of storage mediums including a flash memory, a hard disk, a multimedia card micro type memory, a card-type memory (e.g., SD or DX memory, etc), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The decoder 340 decodes encoded multimedia content.

The display 350 displays information such as multimedia content.

The first event receiver 400 includes a controller 410, a network interface 420, a memory 430, a decoder 440, and a display 450.

Roles of the components of the first event receiver 400 may be identical to those of the event generator 300.

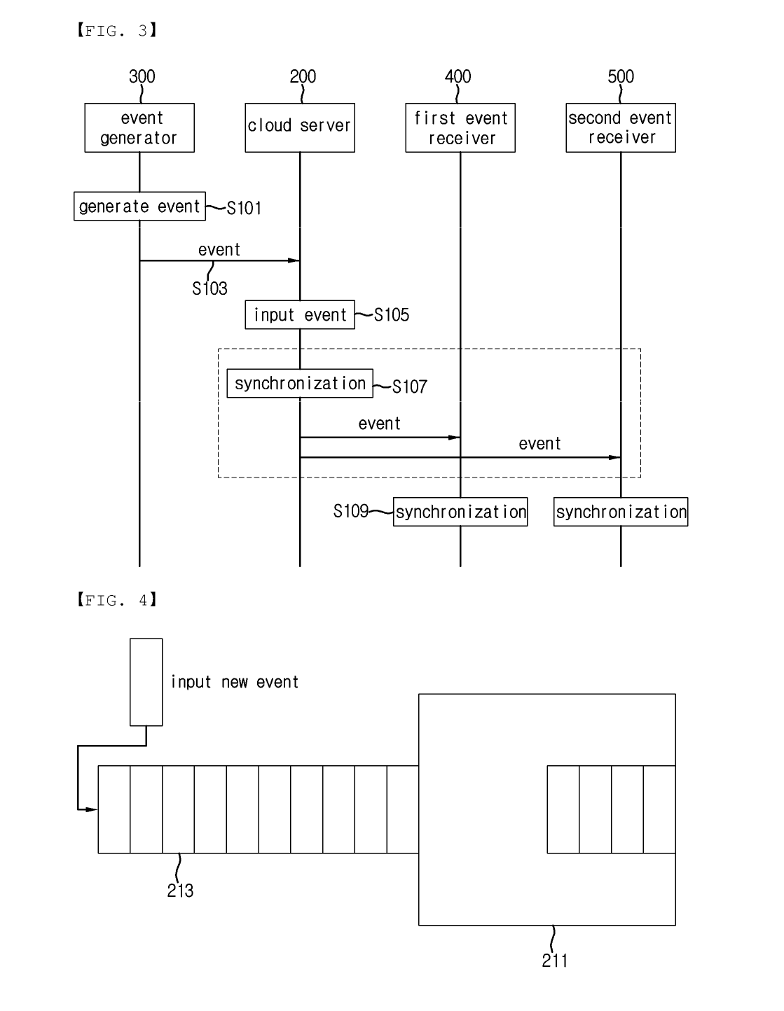

A synchronization operation according to an embodiment of the present invention will be described with reference to FIGS. 3 through 5.

FIG. 3 is a ladder diagram illustrating a synchronization operation of the cloud system according to an embodiment of the present invention.

When an operation requires synchronization, the event generator 300 generates a synchronization event (S101). As described above, the operation that requires synchronization may be adding, deleting, or editing a multimedia file, document data, an application and application data, social network service (SNS) data, a mail, etc.

The event generator 300 transmits the synchronization event to the cloud server device 200.

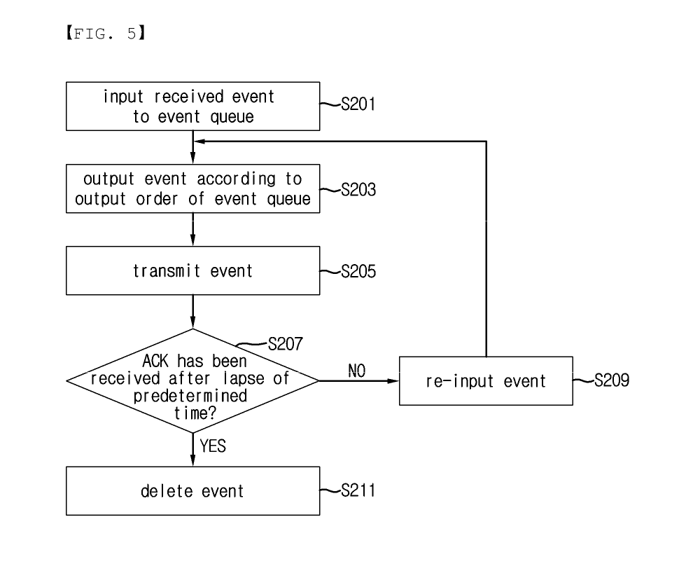

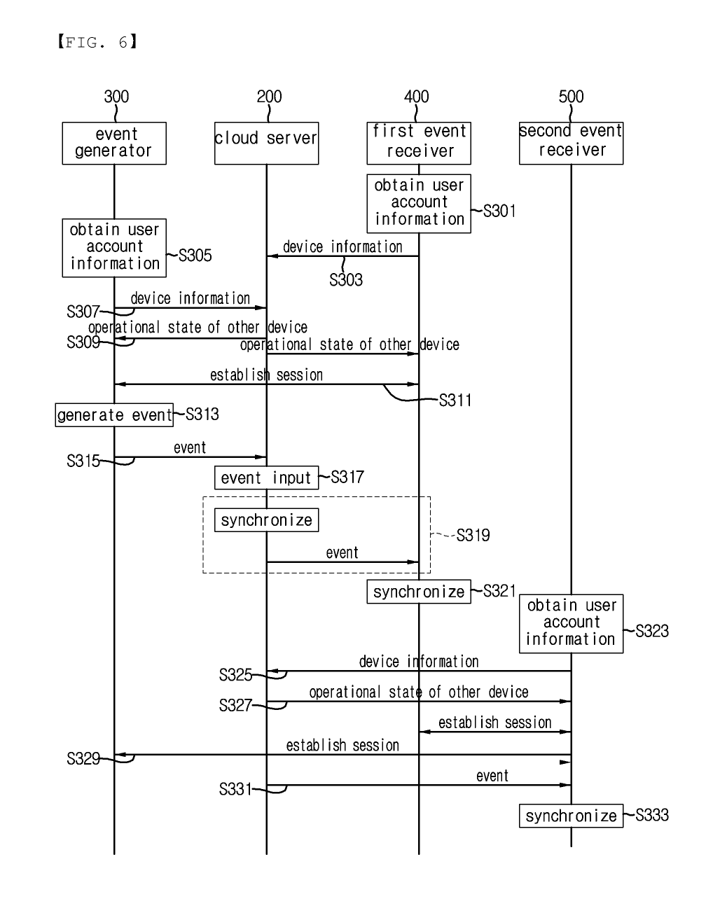

The controller 210 of the cloud server device 200 receives the event and inputs the received event to an event queue (S105). An output order of the event queue and an event processing operation of the cloud server device 200 will be described in detail with reference to FIGS. 4 and 5.

An event processing module of the controller 210 of the cloud server device 200 processes events according to an output order of the event queue (S107). When the cloud server device 200 receives the synchronization event, the event processing module synchronizes information of the content storage unit 240 and transmits the event to a plurality of event receivers which belong to the same owner or which are set to share information. Namely, the event processing module changes information stored in the content storage unit 240 into information identical to that of the event generator 300. Also, in the embodiment of FIG. 3, the event processing module transmits the synchronization event to the first event receiver 400 and the second event receiver 500. In this case, transmitting the synchronization event to each of the event receivers may be handled as a separate event or may be handled as a single vent.

Upon receiving the synchronization event, the plurality of event receivers synchronize information thereof (S109). In the embodiment of FIG. 3, the first event receiver 400 and the second event receiver 500 synchronize information of the second event receiver 500.

FIG. 4 is a view illustrating inputting and outputting of an event queue of a cloud server device and an operation of an event processing module according to an embodiment of the present invention.

An event queue 213 is a repository in which events are on standby before an operation of the event processing module 213 is performed according to an event. In the embodiment of FIG. 4, the event queue 213 follows a first-in first-out scheme. Events that arrive first at the event queue 213 are first output. Thus, if a large amount of events are on standby before the synchronization event arrives at the event queue 213, the synchronization events cannot be processed until when the events on standby are all processed.

An event processing module 211 performs an operation according to an event. When the synchronization event is input, the event processing module 211 synchronizes information of the content storage unit 240 of the cloud server device 200 according to the synchronization event. Also, the event processing module 211 transmits the event to event receivers which belong to the same user or which are set to share information based on user account information of the event generator. In particular, the event processing module 211 may transmit the event according to uniform resource locators (URLs) of the event receivers.

As the number of users who use the cloud system 100 increases, the number of various events to be processed by the event processing module 211 increases. Thus, there is a high possibility that processing of the synchronization event will be delayed to delay synchronization between client devices. When synchronization is delayed, although information stored in any one of the client devices which belong to the same user or which are set to share information has been changed, information stored in other client devices is not changed, and thus, the user may not immediately use the same information. In this case, the user should wait for synchronization and reliability of performance of the cloud system 100 and the client devices is degraded.

FIG. 5 is a flow chart illustrating processing of a synchronization event of a cloud server device according to an embodiment of the present invention.

The controller 210 of the cloud server device 200 inputs received event to the event queue (S201).

The event queue 213 outputs an event according to output order (S203). The outputting of the event by the event queue 213 is based on the FIFO scheme as described above with reference to FIG. 4. If a large amount of events are on standby before the synchronization event is input to the event queue 213, the synchronization event may not be processed until when the events are all processed.

The event processing module 211 transmits the output event to event receivers which belong to the same user or which are set to share information (S205). While one event is processed, an event may be transmitted to one event receiver, but according to an embodiment, the synchronization event may be transmitted to a plurality of event receivers. The event processing module 211 may transmit the event according to URLs of the event receivers.

After the lapse of a predetermined time, the event processing module 211 determines whether an acknowledgement (ACK) message has been received (S207). Namely, the event processing module 211 determines whether the event receivers have received the synchronization event through the ACK message.

When the cloud server device 200 fails to receive the ACK message, the event processing module 211 re-inputs the synchronization event to the event queue 213 (S209). Re-inputting of the event to the event queue 213 is because the event receiver (s) have not received the event. In a case in which a synchronization event is transmitted to a plurality of event receivers while one event is being processed, if ACK messages have not been received from all of the plurality of event receivers, the event processing module 211 may re-input the event. In this case, to an event receiver from which an ACK message has been received, the synchronization event is not transmitted again.

When the cloud server device 200 receives an ACK message, the controller deletes the processed event (S211).

In particular, in a case in which one event corresponds to one event receiver that has transmitted an ACK message, the controller 210 may delete the processed event.

Meanwhile, in a case in which one event corresponds to a plurality of event receivers and the event is transmitted by using URLs of the event receivers, the controller 210 may delete URLs of event receivers which have transmitted an ACK message from the event. Here, if an event includes a URL of an event receiver which has not been deleted, the controller 180 may re-input the corresponding event to the event queue. When an event does not include any URL of an event receiver, the controller 210 may delete the corresponding event.

A synchronization operation according to another embodiment of the present invention will be described with reference to FIGS. 6 through 10.

FIG. 6 is a ladder diagram illustrating a synchronization operation of a cloud system according to another embodiment of the present invention.

The first event receiver 400 obtains user account information (S301). The first event receiver 400 may obtain account information through a user input. The first event receiver 400 may read previously stored account information to obtain the account information according to an embodiment. In this case, the account information may include an ID and a password.

The first event receiver 400 transmits device information of the first event receiver 400 to the cloud server device 200 (S303). Namely, the cloud server device 200 receives the device information of the client device from the client device. In the embodiment of FIG. 6, the cloud server device 200 receives the device information of the first event receiver 400 from the first event receiver 400. In this case, the device information may include at least one among account information of the first event receiver 400 and whether power of the first event receiver 400 is turned on. When the device information includes account information of the first event receiver 400, the cloud server device 200 reviews validity of the account information, and when the account information is valid, the cloud server device 200 permits the first event receiver 400 to access the account. When the account information is not valid, the cloud server device 200 does not permit the first event receiver 400 to access the account.

The event generator 300 obtains user account information (S305). The event generator 300 may obtain the account information in the same manner as that of the first event receiver 400.

The event generator 300 transmits device information of the event generator 300 to the cloud server device 200 (S307). Namely, the cloud server device 200 receives device information of the event generator 300 from the event generator 300. The device information may include at least one among account information of client devices and whether power of the client devices is turned on. When the device information includes account information of the event generator 300, the cloud server device 200 reviews validity of the account information, and when the account information is valid, the cloud server device 200 permits the event generator 300 to access the account. When the account information is not valid, the cloud server device 200 does not permit the event generator 300 to access the account.

The cloud server device 200 transmits operational states of the client devices which belong to the same user or which are set to share information, to the client device which has transmitted the account information (S309). The operational states may include at least one among whether the client devices have accessed the account and whether power of the client devices is turned on. In the embodiment of FIG. 6, the cloud server device 200 transmits an operational state of the first event receiver 400 as a client device which belongs to the same user as that of the event generator 300 or which is set to share information, to the event generator 300. In the embodiment of FIG. 6, the cloud server device 200 transmits an operational state of the event generator 300 as another client device which belongs to the same user as that of the first event receiver 400 or which is set to share information, to the first event receiver 400.

Thereafter, the event generator 300, the first event receiver 400, and the cloud server device 200 establish a logical session between the event generator 300 and the first event receiver 400 (S311).

In detail, when the cloud server device 200 receives device information from the event generator 300, the cloud server device 200 checks one or more logical session establishment-available client devices available to establish a logical session with the event generator 300 as a client device that has transmitted the device information. In this case, the cloud server device 200 may check one or more logical session establishment-available client devices, based on operational states and sharing relationships of the client devices that the cloud server device 200 serves. For example, the cloud server device 200 may determine a client device which belongs to the user of the event generator 300 or that has a sharing relationship with the event generator 300, among client devices which are connected to the account or which are turned on, as a logical session establishment-available client device. The cloud server device 200 may establish a logical session between the event generator 300 and the logical session establishment-available client device. In the embodiment of FIG. 6, the logical session establishment-available client device is the first event receiver 400, and thus, the cloud server device 200 establishes a logical session between the event generator 300 and the first event receiver 400.

Meanwhile, based on a request for establishing a logical session from the event generator 300 which has received an operational state of other device or a request for establishing a logical session from the first event receiver 400 which has received an operational state of other device, the cloud server device 200 may establish a logical session between the event generator 300 and the first event receiver 400.

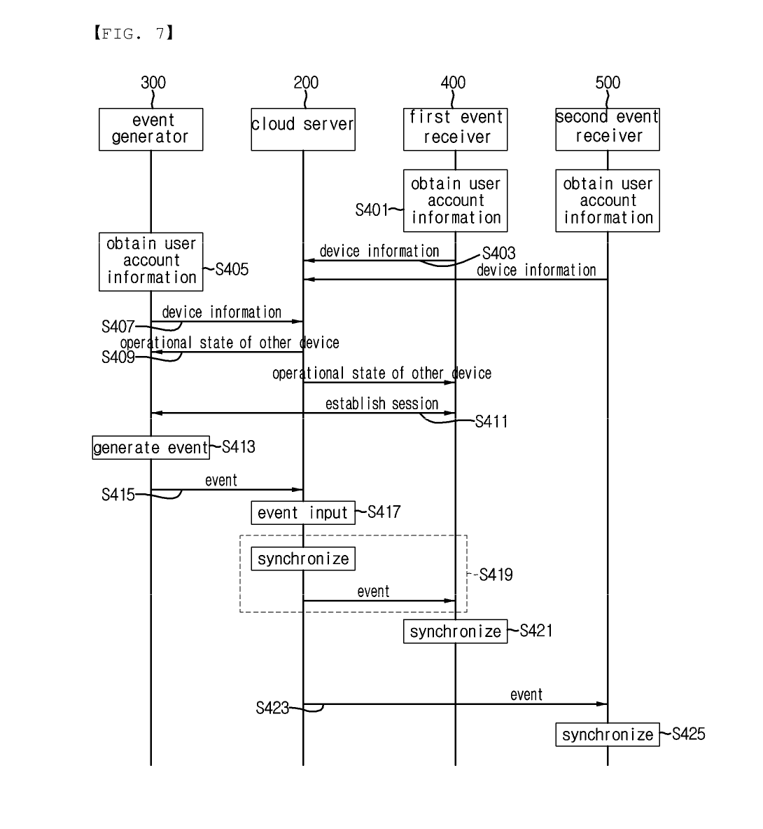

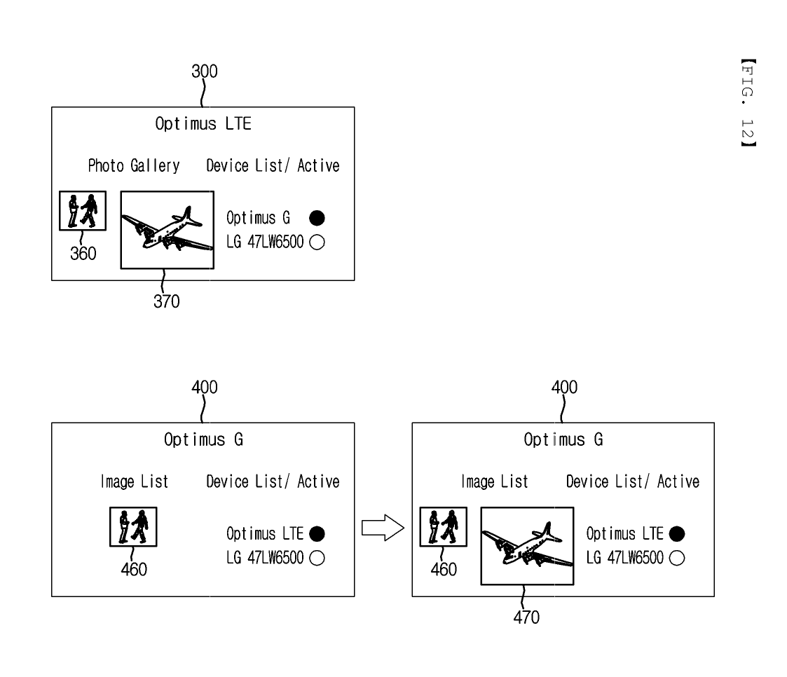

A logical session refers to a logical connection for transmitting an event between client devices. Since an event is more rapidly transmitted between logical session-established client devices than between client devices without an established logical session therebetween, and thus, the event may be processed without delay. Namely, the event transmitted through a logical session is transmitted to the client device, preferentially over an event that does not go through any logical session. Here, however, a logical session does not mean a physical connection, and thus, an event may be transmitted to other client device through a server even though a logical session is established between client devices. Namely, a logical session may be established between client devices without going through the cloud server, and according to an embodiment, a logical session may be established between client devices through the cloud server device. In the embodiment of FIGS. 6 and 7, even though a logical session is established between the cloud devices, an event may be transmitted through the cloud server device 20. Transmission of a synchronization event without going through the cloud server device 200 when a logical session is established will be described with reference to FIG. 11.

When an operation requires synchronization, the event generator 300 generates a synchronization event (S313). The operation that requires synchronization may include adding, deleting, and editing a multimedia file, a document data, an application and application data, social network service (SNS) data, and a mail, as mentioned above.

The event generator 300 transmits the synchronization event to the cloud server device 200 (S315).

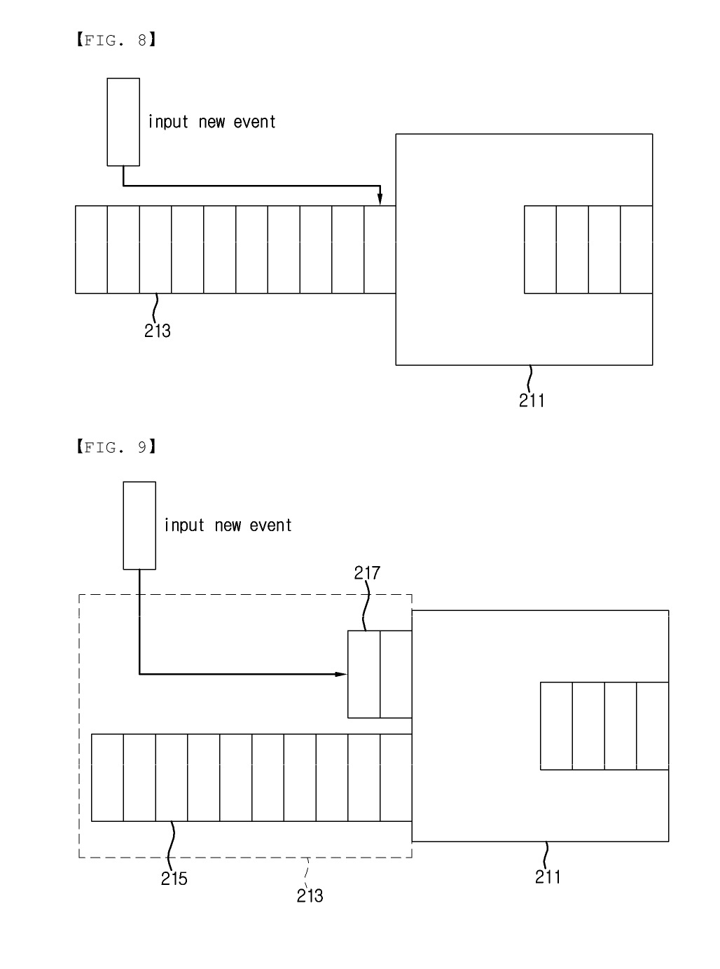

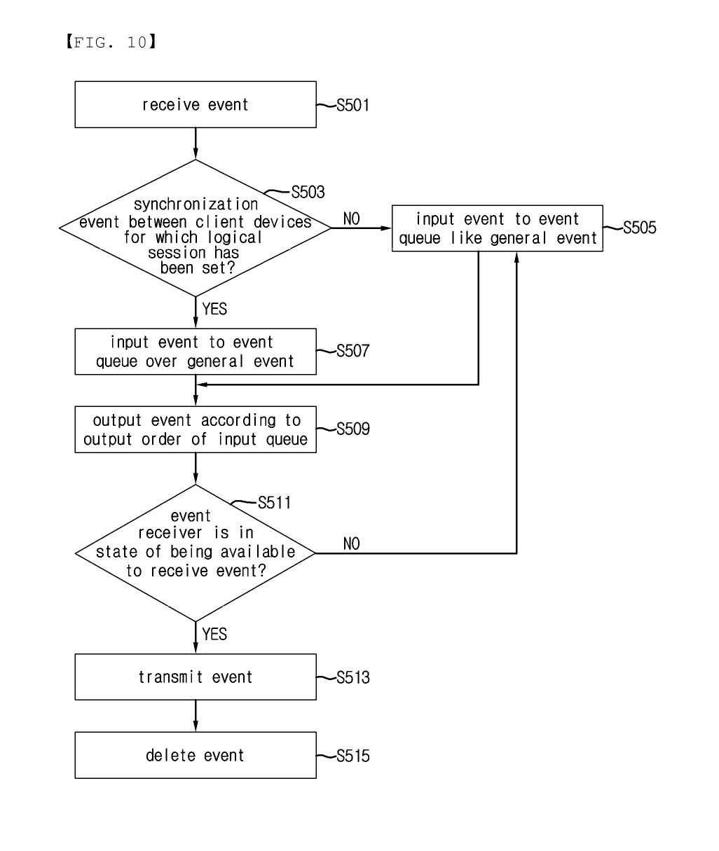

The controller 210 of the cloud server device 200 inputs the event transmitted to the event queue (S317). Output order of the event queue and a corresponding event processing operation of the cloud server device 200 will be described in detail with reference to FIGS. 8 and 9.

The event processing module of the controller 210 of the cloud server device 200 processes events according to output order of the event queue (S319). When the cloud server device 200 receives a synchronization event, the event processing module synchronizes information of the content storage unit 240 and transmits the event to event receivers which belong to the same owner as that of the event generator 300 or which are set to share information. Here, in a case in which a logical session has been established between the event generator 300 and the event receivers, the event processing module transmits the event through the logical session. Since the event is transmitted through the logical session between the event generator 300 and the event receivers, the event may be transmitted without delay. The transmission method through a logical session will be described in detail with reference to FIGS. 8 and 9. In the embodiment of FIG. 6, the event processing module transmits the synchronization event through the logical session to the first event receiver 400 in a logical session established with the event generator 300.

The first event receiver 400 synchronizes information thereof according to the synchronization event (S321).

The second event receiver 500 obtains user account information (S323). In this case, the second event receiver 500 may obtain account information in the same manner as that of the first event receiver.

The second event receiver 500 transmits device information thereof to the cloud server device 200 (S325). Namely, the cloud server device 200 receives the device information of the second event receiver 500 from the second event receiver 500. An operational state may include at least one among whether client devices are connected to an account and whether power of the client devices is turned on.

The cloud server device 200 transmits operational states of the other client devices which belong to the same user or which are set to share information, to the second event receiver 500 (S327). In the embodiment of FIG. 6, the cloud server device 200 transmits operational states of the event generator 300 and the first event receiver 400 to the second event receiver 500.

The cloud server device 200 establishes a logical session for connecting the client devices based on the operational states of the client devices which belong to the same user as that of the second receiver 500 or which are set to share information (S329). The cloud server device 200 establishes a logical session for connecting the second event receiver 500, the event generator 300, and the first event receiver 400.

The cloud server device 200 transmits the synchronization event to the second event receiver 500 through the logical session (S331).

The second event receiver 500 synchronizes information of the first event receiver 400 according to the synchronization event (S333).

FIG. 7 is a ladder diagram illustrating comparison between a synchronization operation of a cloud system according to an embodiment of the present invention and a synchronization operation thereof according to another embodiment of the present invention.

In FIG. 7, the event generator 300 is synchronized with the first event receiver 400 according to another embodiment and is synchronized with the second event receiver 500 according to an embodiment. Namely, a logical session is established between the event generator 300 and the first event receiver 400, but a logical session is not established between the event generator 300 and the second event receiver 500.

The first event receiver 400 and the second event receiver 500 obtain user account information (S401). The first event receiver 400 and the second event receiver 500 may obtain account information through a user input. The first event receiver 400 and the second event receiver 500 may read previously stored account information to obtain account information according to an embodiment. In this case, the account information may include an ID and a password.

The first event receiver 400 and the second event receiver 500 transmit device information of the first event receiver 400 and device information of the second event receiver 500 to the cloud server device 200, respectively (S403). Namely, the cloud server device 200 receives the device information of the first event receiver 400 and the device information of the second event receiver 500 from the first event receiver 400 and the second event receiver 500. The device information may include account information of client devices and whether power of the client devices is turned on. When the device information includes account information of the first event receiver 400 and the second event receiver 500, the cloud server device 200 reviews validity of the account information, and when the account information is valid, the cloud server device 200 permits the first event receiver 400 and the second event receiver 500 to access the account. When the account information is not valid, the cloud server device 200 does not permit the first event receiver 400 and the second event receiver 500 to access the account.

The event generator 300 obtains user account information (S405). The event generator 300 may obtain the user account information in the same manner as those of the first event receiver 400 and the second event receiver 500.

The event generator 300 transmits device information of the event generator 300 to the cloud server device 200 (S407). Namely, the cloud server device 200 receives device information of the event generator 300 from the event generator 300. The device information may include at least one among account information of client devices and whether power of the client devices is turned on.

The cloud server device 200 transmits operational states of client devices which belong to the same user as that of the event generator 300 or which are set to share information, to the event generator 300 (S409). In the embodiment of FIG. 7, the cloud server device 200 transmits an operational state of the first event receiver to the event generator 300. In the case of the second event receiver 500, an embodiment of the present invention is applied to the second event receiver 500, and thus, the cloud server device 200 does not transmit an operational state of the second event receiver 500 to the event generator 300.

The cloud server device 200 establishes a logical session for connecting client devices based on operational states of client devices which belong to the same user or which are set to share information (S411). In the embodiment of FIG. 7, since the event generator 300 and the first event receiver 400 are connected to the user account, the cloud server device 200 establishes a logical session for connecting the event generator 300 and the first event receiver 400. In the case of the second event receiver 500, an embodiment of the present invention is applied to the second event receiver 500, and thus, the cloud server device 200 does not establish a logical session between the event generator 300 and the second event receiver 500. A specific method for establishing a logical session is the same as that described above with reference to FIG. 6.

When an operation requires synchronization, the event generator 300 generates a synchronization event (S413). As described above, the operation that requires synchronization may be adding, deleting, or editing a multimedia file, document data, an application and application data, social network service (SNS) data, a mail, etc.

The event generator 300 transmits the synchronization event to the cloud server device 200 (S415).

The controller 210 of the cloud server device 200 inputs the transmitted event to the event queue (S417).

The event processing module of the controller 210 of the cloud server device 200 processes events according to an output order of the event queue (S419). When the cloud server device 200 receives the synchronization event, the event processing module synchronizes information of the content storage unit 240 and transmits the event to a plurality of event receivers which belong to the same owner or which are set to share information.

In the embodiment of FIG. 7, the event processing module transmits a synchronization event to the first event receiver 400 in a logical session established with the event generator 300 through the logical session. However, the event processing module transmits the synchronization event to the second event receiver 500 without a logical session established with the event generator 300, without going through a logical session. Thus, the event processing module transmits the event first to the first event receiver 400 than to the second event receiver 500.

The first event receiver 400 synchronizes information within the first receiver 400 according to the synchronization event (S421).

The event processing module of the controller 210 of the cloud server device 200 transmits the synchronization event to the second event receiver 500 (S423). As described above, since a logical session is not established between the event generator 300 and the second event receiver 500, the synchronization event transmitted from the event generator 300 is processed in the same manner as that of other types of events. Thus, even though the second event receiver 500 has transmitted the account information simultaneously when the first event receiver 400 has transmitted the account information, since a logical session is not established therefor, the second event receiver 500 receives the synchronization event after the lapse of a great amount of time, compared with the first event receiver 400.

The second event receiver 500 synchronizes information of the first event receiver 400 according to the synchronization event (S425).

An operation embodiment of the event processing module 211 for performing synchronization without delay when a synchronization event is transmitted through a logical session will be described with reference to FIGS. 8 and 9. Namely, a method for processing a synchronization event between client devices in an established logical session, preferentially over other events, will be described.

FIG. 8 is a view illustrating an example of an operation method of an event processing module of a cloud server device according to another embodiment of the present invention.

An operation of the event processing module 211 according to another embodiment of FIG. 8 has the same configuration as that of the event processing module according to the embodiment of FIG. 4. However, when a synchronization event between client devices for which a logical session has been established is input to the event queue 213, the synchronization event between the client devices for which the logical session has been established is first output over other events in order, regardless of input order, as an exception of the FIFO scheme. Thus, the synchronization event between the client devices for which the logical session has been established is preferentially processed over other events on standby before the cloud server device 200 receives the synchronization event.

In a case in which a certain number of synchronization events with respect to client devices for which a logical session has been established is processed, the events may be processed according to the FIFO scheme.

Also, even in a case in which a logical session is established after a synchronization event is transmitted to the cloud server device 200, a synchronization event may be transmitted through the logical session. To this end, in a case in which a logical session is established while a synchronization event is on standby in the event queue 213, output order may be changed such that the synchronization event is output over other events, as an exception of the FIFO scheme.

FIG. 9 is a view illustrating another example of an operation method of an event processing module of a cloud server device according to another embodiment of the present invention.

In the operation method of the event processing module 211 according to the embodiment of FIG. 9, a configuration of the event processing module is the same as those of FIGS. 4 and 8, except for a method of inputting an event to the event processing module 211, namely, to the event queue 211.

The event queue 211 includes a general event queue 215 and a preferential event queue 217. General events are input to the general event queue 215, and a synchronization event between client devices connected in a logical session is input to the preferential event queue 217. The event processing module 211 receives events from the event queues.

In order to preferentially process the events input to the preferential event queue 217, the event processing module 211 may receive all the events on standby in the preferential event queue 217 and subsequently receive the events on standby in the general event queue 215.

Alternatively, by adjusting a processing rate of the events on standby in the preferential event queue 217 and a processing rate of the events on standby in the general event queue 215 to be identical or by increasing the processing rate of the events on standby in the preferential queue 217, the events on standby in the preferential event queue 217 may be preferentially processed. Since there is a high possibility in which the number of other events is greater than number of synchronization events with respect to client devices for which a logical session is established, when events on standby in the preferential event queue 217 and the general event queue 215 are processed at the same rate, the events on standby in the preferential event queue 217 may be first processed although the events arrive at the cloud server device 200 at the same time.

Also, even in a case in which a synchronization event is transmitted to the cloud server device 200 and a logical session is established, the synchronization event is transmitted through the logical session. To this end, while a synchronization event is on standby in the general event queue 215, when a logical session is established between client devices as subjects of the synchronization event, the synchronization event may be shifted to the preferential event queue 217.

In a case in which a plurality of logical sessions exist, different priorities may be set for the logical sessions to determine event processing order. For example, client devices of the user may take priority over client devices client devices set to share information. In this case, the client devices of the user is highly likely to be guaranteed for delay-free synchronization, compared to a case in which the client devices have the same priority. In a case in which a plurality of logical sessions have different priorities, the preferential event queue 217 may be divided according to the priorities.

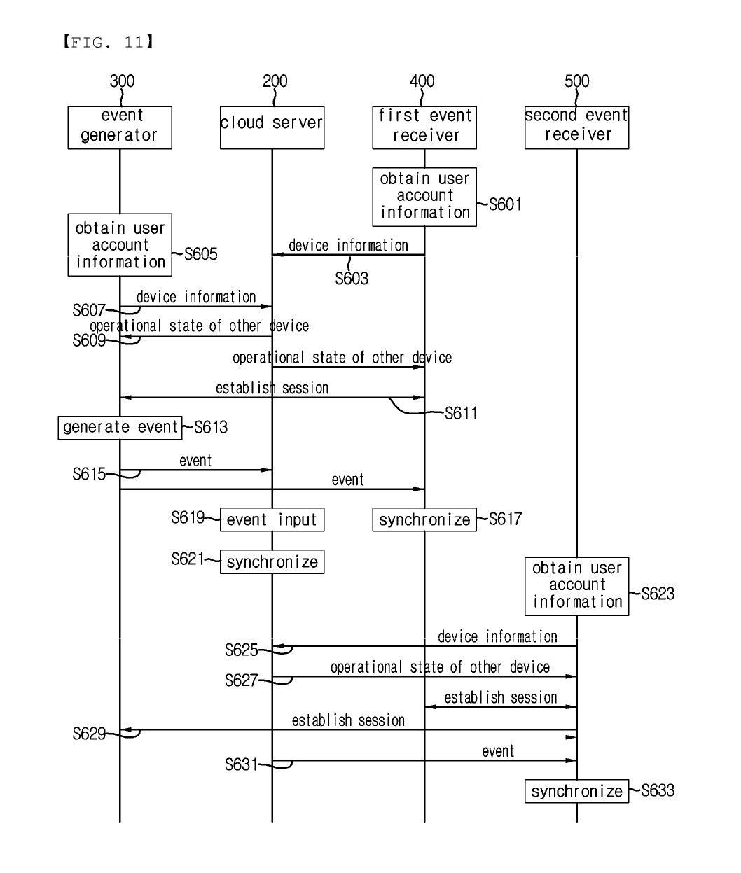

FIG. 10 is a flow chart illustrating synchronization event processing of a cloud server device according to another embodiment of the present invention.

The cloud server device 200 receives an event (S501).

The controller 210 of the cloud server device 200 determines whether an event transmitted to the cloud server device 200 is a synchronization event between client devices for which a logical session has been established (S503). Namely, the controller 210 checks connection between the event generator 300 and an event receiver. While processing one event, the controller 210 may transmit an event to one event receiver, but according to an embodiment, the controller 210 may transmit a synchronization event to a plurality of event receivers, while processing one event. In a case in which a synchronization event with respect to a plurality of events is transmitted through one event, if there is one or more event receivers for which a logical session has been established, among thee plurality of event receivers, it is determined as a synchronization event with respect to the one or more event receivers for which a logical session has been established. The event processing module 211 may transmit an event according to a URL of an event receiver.

If an event transmitted to the cloud server device 200 is not a synchronization event with respect to a client device for which a logical session has been established, the controller 210 of the cloud server device 200 inputs the transmitted event to the event queue in the same manner as that of a general event (S505).

In a case in which an event transmitted to the cloud server device 200 is a synchronization event with respect to a client device for which a logical session has been established, the controller 210 of the cloud server device 200 processes the transmitted event preferentially over a general event (S507). Namely, the controller 210 of the cloud server device 200 inputs the event to the event queue, by taking priority over a general event. The method of inputting an event to the event queue, by taking priority over a general event, is based on the embodiment described above with reference to FIGS. 8 and 9.

The event queue 213 outputs events according to output order (S509). Unlike the embodiment of FIG. 5, the event queue 213 is not based on a FIFO scheme and preferentially outputs a preferentially input synchronization event between the event generator 300 and an event receiver for which a logical session has been established.

The event processing module 211 determines whether an event receiver for receiving an output event is in an event reception-available state (S5511). Compared to the case of the embodiment of FIG. 5 in which an event is transmitted and whether the transmission is successfully made is determined through an ACK message, in the embodiment of FIG. 10, an event is transmitted only when an event receiver is currently in an event reception-available state. The event reception-available state may include at least one of a state in which power is currently turned on and a state in which an account is connected. In a case in which an event is transmitted to a plurality of event receivers, the event may be transmitted only to event receivers that are currently in an event reception-available state.

When an event receiver is currently not in an event reception-available state, the event processing module re-inputs the event to the event queue 213 in the same manner as that of a general event.

When an event receiver is currently in an event reception-available state, the event processing module 211 transmits the output event to an event receiver which belongs to the same use or which is set to share information (S513). In this case, the event processing module 11 may transmit the event according to URLs of event receivers.

The controller 210 deletes the processed event (S515).

In particular, when one transmitted event corresponds to one event receiver, the controller 210 may delete the processed event.

Meanwhile, when one event corresponds to a plurality of event receivers and the event is transmitted by using URLs of the event receivers, the controller 210 may delete the URLs of event receivers which have transmitted an ACK message in the event. In this case, when the event includes a URL of an event receiver which has not been deleted, the controller 210 may re-input the corresponding event to the event queue. When an event does not include any URL of a receiver, the controller 210 may delete the corresponding event.

FIG. 11 is a ladder diagram illustrating a synchronization operation of a cloud system according to another embodiment of the present invention.

The first event receiver 400 obtains user account information (S601). The first event receiver 400 may obtain account information through a user input. The first event receiver 400 may read previously stored account information to obtain the account information according to an embodiment. In this case, the account information may include an ID and a password.

The first event receiver 400 transmits device information of the first event receiver 400 to the cloud server device 200 (S603). Namely, the cloud server device 200 receives the device information of the client device from the client device. In the embodiment of FIG. 11, the cloud server device 200 receives the device information of the first event receiver 400 from the first event receiver 400. In this case, the device information may include at least one among account information of the first event receiver 400 and whether power of the first event receiver 400 is turned on. When the device information includes account information of the first event receiver 400, the cloud server device 200 reviews validity of the account information, and when the account information is valid, the cloud server device 200 permits the first event receiver 400 to access the account. When the account information is not valid, the cloud server device 200 does not permit the first event receiver 400 to access the account.

The event generator 300 obtains user account information (S605). The event generator 300 may obtain the account information in the same manner as that of the first event receiver 400.

The event generator 300 transmits device information of the event generator 300 to the cloud server device 200 (S607). Namely, the cloud server device 200 receives device information of the event generator 300 from the event generator 300. The device information may include at least one among account information of client devices and whether power of the client devices is turned on. When the device information includes account information of the event generator 300, the cloud server device 200 reviews validity of the account information, and when the account information is valid, the cloud server device 200 permits the event generator 300 to access the account. When the account information is not valid, the cloud server device 200 does not permit the event generator 300 to access the account.

The cloud server device 200 transmits operational states of the client devices which belong to the same user or which are set to share information, to the client device which has transmitted the account information (S609). The operational states may include at least one among whether the client devices have accessed the account and whether power of the client devices is turned on. Also, the operational states may include identifiers of the client devices, for example, URLs of the client devices. In the embodiment of FIG. 11, the cloud server device 200 transmits an operational state of the first event receiver 400 as a client device which belongs to the same user as that of the event generator 300 or which is set to share information, to the event generator 300. In the embodiment of FIG. 6, the cloud server device 200 transmits an operational state of the event generator 300 as another client device which belongs to the same user as that of the first event receiver 400 or which is set to share information, to the first event receiver 400.

The client devices establish a logical session connecting the client devices based on operational states of the client devices which belong to the same user or which are set to share information (S611). Namely, the client devices establish a logical session connecting the client devices based on at least one among whether the client devices which belong to the same user or which are set to share information have accessed an account or whether power of the client devices is turned on. In a specific embodiment, when the client devices have accessed an account of the same owner (or same user) or when the client devices have accessed an account in a sharing relationship, the client devices may establish a logical session therebetween. In another embodiment, when power of the client devices is turned on, the client devices may establish a logical session therebetween. In the embodiment of FIG. 11, since the event generator 300 corresponds to at least one among a case in which the first event receiver 400 has accessed an account that the event generator 300 has accessed and a case in which the first event receiver 400 has accessed an account in a sharing relationship with an account that the event generator 300 has accessed, the event generator 300 and the first event receiver 400 establish a logical session connecting each other.

When an operation requires synchronization, the event generator 300 generates a synchronization event (S613). The operation that requires synchronization may include adding, deleting, and editing a multimedia file, a document data, an application and application data, social network service (SNS) data, and a mail, as mentioned above.

The event generator 300 transmits the synchronization event to the cloud server device 200 and an event receiver for which a logical session has been established (S615). In the embodiment of FIG. 11, the event generator 300 may directly transmit an event to the first event receiver 400 for which a logical session has been established with the event generator 300, without going through a server. In this case, the event generator 300 may use a URL included in an operational state of the first event receiver 400. In the case in which the event is directly transmitted to the event receiver for which a logical session has been established, without going through a server, since the event is not transmitted until other events which have first arrived at the cloud server device 200 as in the embodiment of the present invention are processed, and thus, synchronization may be performed quickly.

The first event receiver 400 synchronizes information thereof according to the synchronization event (S617).

The controller 210 of the cloud server device 200 inputs an event transmitted to the event queue (S619).

The event processing module in the controller 210 of the cloud server device 200 processes the events according to output order of the event queue (S621). When the cloud server device 200 receives a synchronization event, the event processing module synchronizes information of the content storage unit 240.

The second event receiver 500 obtains user account information (S623). In this case, the second event receiver 500 may obtain account information in the same manner as that of the first event receiver.

The second event receiver 500 transmits device information thereof to the cloud server device 200 (S625).

The cloud server device 200 transmits operational states of the other client devices which belong to the same user or which are set to share information to the second event receiver 500 (S627). In the embodiment of FIG. 11, the cloud server device 200 transmits operational states of the event generator 300 and the first event receiver 400 to the second event receiver 500.

The second event receiver 500 establishes a logical session connecting the second event receiver and the client devices based on operational states of the client devices which belong to the same user or which are set to share information (S629). The second event receiver 500, the event generator 300, and the first event receiver 400 establish a logical session connecting each of the second event receiver, the event generator 300, and the first event receiver 400.

The event generator 300 transmits the synchronization event directly to the second event receiver 500 through the logical server, without going through the server (S631). In this case, according to an embodiment, one of the event receivers which have already been synchronized, as well as the event generator 300 which has first generated the event, may transmit the synchronization event to the second event receiver. In particular, for rapid synchronization, by comparing data transfer rates of the event generator 300 and the event receivers, and a client device having the fastest data transfer rate may transmit the synchronization event.

The second event receiver 500 synchronizes information of the first event receiver 400 according to the synchronization event (S633).

FIG. 12 is a view illustrating graphic user interface (GUI) screens illustrating synchronization of image files among client devices according to an embodiment of the present invention.

Each of the client devices displays a list of client devices which belong to the same user or which are set to share information on a graphic user interface (GUI). In this case, the client devices may display operational states of the client devices which belong to the same user or which are set to share information, together. In an embodiment of FIG. 12, the event generator 300 is a mobile phone under the model name of Optimus LTE. The first event receiver 400 is a mobile phone under the model name of Optimus G. The second event receiver 500 is a TV under the model name of LG47LW6500. The event generator 300 which is currently turned on displays names and operational states of the first event receiver 400 and the second event receiver 500 which belong to the same user or which are set to share information. The first receiver 400 which is currently turned on also displays names and operational states of the event generator 300 and the second event receiver 500. According to an embodiment, whether a client device has accessed an account, as well as power thereof is turned on, may also be displayed. In this case, the cloud server device 200 may establish a logical session based on operational states of other client devices. Namely, the cloud server device 200 establishes a logical session connecting the event generator 300 and the first event receiver 400. Here, in an embodiment in which a synchronization event is directly transmitted without going through the cloud server device, the event generator 300 and the first event receiver 400 establish a logical session connecting the event generator 300 and the first event receiver 400.

When the event generator 300 generates a new synchronization event, event receivers receive the synchronization event synchronization event and are synchronized. In the embodiment of FIG. 12, the event generator 300 performs image capturing to add a new photograph image 370. Thus, a photo gallery application displays the new photograph image 370 as well as an existing image 360. The first event receiver 400 connected in a logical session receives the synchronization event through the logical session without delay. The first event receiver 400 performs synchronization to add a newly added photograph image 470 in addition to an existing image 460.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. An operation method of a first client device, the operation method comprising:
transmitting device information of the first client device to a cloud server device;
receiving an operational state of a second client device from the cloud server device;
establishing a logical session with the second client device based on the operational state; and
transmitting a first event through the logical session,
wherein the first event is transmitted to the second client device preferentially over a second event which does not go through any logical session.

2. The operation method of claim 1, wherein the operational state comprises whether the second client device has accessed an account, and
the establishing of a logical session comprises: when the second client device accesses an account that the first client device has accessed, establishing the logical session.

3. The operation method of claim 1, wherein the operational state comprises whether the second client device has accessed an account, and
the establishing of a logical session comprises: when the second client device accesses an account in a sharing relationship with the account that the first client device has accessed, establishing the logical session.

4. The operation method of claim 1, wherein the operational state comprises whether power of the second client device is turned on, and
the establishing of a logical session comprises: when the power of the second client device is turned on, establishing the logical session.

5. The operation method of claim 1, wherein the logical session is a session established between the first client device and the second client device through the cloud server device.

6. The operation method of claim 1, wherein the logical session is a session established between the first client device and the second client device, without going through the cloud server device.

7. The operation method of claim 1, wherein the event is a synchronization event.

8. The operation method of claim 1, wherein the device information comprises at least one among account information and whether power is turned on.

9. A client device as a first client device, comprising:
a network interface configured to connect a cloud server device and a second client device to the first client device; and
a controller configured to transmit device information of the first client device to the cloud server device, receive an operational state of the second client device from the cloud server device, establish a logical session with the second client device based on the operational state, and transmit a first event through the logical session,
wherein the first event is transmitted to the second client device preferentially over a second event that does not go through any logical session.

10. The client device of claim 9, wherein the operational state comprises whether the second client device has accessed an account, and
when the second client device accesses an account that the first client device has accessed, the controller establishes the logical session.

11. The client device of claim 9, wherein the operational state comprises whether the second client device has accessed an account, and
when the second client device accesses an account in a sharing relationship with the account that the first client device has accessed, the controller establishes the logical session.

12. The client device of claim 9, wherein the operational state comprises whether power of the second client device is turned on, and
when the power of the second client device is turned on, the controller establishes the logical session.

13. The client device of claim 9, wherein the logical session is a session established between the first client device and the second client device through the cloud server device.

14. The client device of claim 9, wherein the logical session is a session established between the first client device and the second client device, without going through the cloud server device.

15. An operation method of a cloud server device, the operation method comprising:
receiving a first event from a first client device;
determining whether the first event is an event for a second client device in a logical session established with the first client device; and
when the first event is an event for the second client device in a logical session established with the first client device, processing the first event preferentially over a second event for a third client device for which any logical session has not been established.

16. The operation method of claim 15, further comprising:
receiving device information of the first client device from the first client device;
receiving device information of the second client device from the second client device; and
establishing the logical session between the first client device and the second client device based on the device information of the first client device and the device information of the second client device.

17. The operation method of claim 16, wherein the device information of the first client device comprises account information of the first client device,
the device information of the second client device comprises account information of the second client device, and
the establishing of a logical session comprises establishing the logical session when the first client device accesses an account and the second client device accesses the account.

18. The operation method of claim 16, wherein the device information of the first client device comprises whether a power of the first client device is turned on,
the device information of the second client device comprises whether power of the second client device is turned on, and
the establishing of a logical session comprises establishing the logical session when the power of the first client device is turned on and power of the second client device is turned on

19. The operation method of claim 15, wherein the processing of a first event preferentially comprises processing the first event preferentially even when the logical session is established between the first client device and the second client device after the cloud server device receives the first event.

20. The operation method of claim 15, wherein the processing of a first event preferentially comprises: inputting the first event to an event queue preferentially over the second event.
